(19) United States
(12) Patent Application Publication
(10) Pub. No.: US 2017/0224112 A1
(43) Pub. Date: Aug. 10, 2017

(54) HEIGHT ADJUSTMENT ARRANGEMENT

(71) Applicant: Gordon Ellis & Company, Castle Donington, Derby (GB)

(72) Inventor: Mark Devereux, Castle Donington, Derby (GB)

(21) Appl. No.: 15/502,177

(22) PCT Filed: Jul. 31, 2015
(86) PCT No.: PCT/GB2015/052211

§ 371 Date: Feb. 6, 2017

(30) Foreign Application Priority Data
Aug. 7, 2014 (GB) 1414033.9

(51) Int. Cl. A47B 91/02; A47B 96/02

(52) U.S. Cl. CPC A47B 91/024; A47B 96/02; A47B 91/022; F16M 7/00

(57) ABSTRACT

A height adjustment arrangement (10) for an item such as a platform (12). The arrangement (10) includes a hollow first member (14) with an external thread (18) which is engageable with a thread on the platform (12) to permit relative height adjustment, and an elongate second member (18) which is engageable with a thread in the interior of the first member (14) to also permit relative height adjustment.

This invention concerns a height adjustment arrangement for an item, and also an adjustable height assembly.

It is often required to provide height adjustment arrangements for items to permit use at different heights and/or to accommodate uneven flooring or ground surfaces. Sometimes problems can be encountered if such arrangements require a certain amount of depth to operate, and the item for which the height is to be adjusted does not and cannot provide sufficient space to accommodate such height.

According to a first aspect of the invention there is provided a height adjustment arrangement for an item, the arrangement including a hollow first member with an external thread which is engageable with a thread on the item to permit relative height adjustment, and an elongate second member which has an external thread which is engageable with a thread in the interior of the first member to permit relative height adjustment.

A stop member may be provided on the first member which is selectively engageable with the item to selectively prevent relative rotational movement between the first member and the item.

The stop member may be automatically engageable with the item, and the arrangement may be configured such that once engaged the stop member requires manual disengagement from the item before the first member can be rotated relative to the item.

The stop member may be spring urged outwardly relative to the remainder of the first member. The stop member may include a resilient part which is located within the first member, and a stop part which is selectively extendible outwardly from the first member.

The first member may include a hollow body within which the resilient part of the stop member is located. An opening may be provided in the hollow body through which the stop part is selectively extendible.

The stop part may be engageable with an opening in the item, which opening may be in the form of at least generally vertically extending slot.

The stop member may be integrally formed, and may be made of plastics material.

A foot may be provided on the lower end of the elongate second member. The second member may be threadably engaged with the foot, and a nut may be provided on the second member to retain the foot and second member mounted together.

A thread may be provided at a lower end in use of the first member, with which the second member threadably engages. A nut may be provided on the second member selectively engageable with the first member to retain the first and second members mounted together at a required relative height.

The second member may be in the form of a threaded bar.

The first member may be integrally formed, and may be made of plastics material.

According to a second aspect of the invention there is provided an adjustable height assembly, the assembly including an item and a height adjustment arrangement according to any of the preceding eleven paragraphs.

An embodiment of the present invention will now be described by way of example only and with reference to the accompanying drawings, in which:

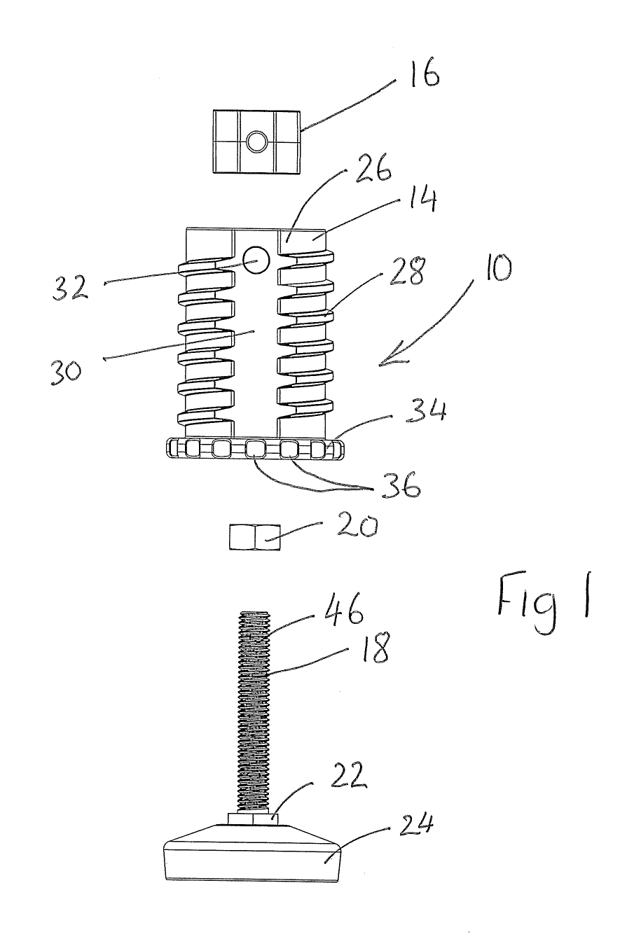

FIG. 1 is a diagrammatic exploded side view of a height adjustment arrangement according to the invention;

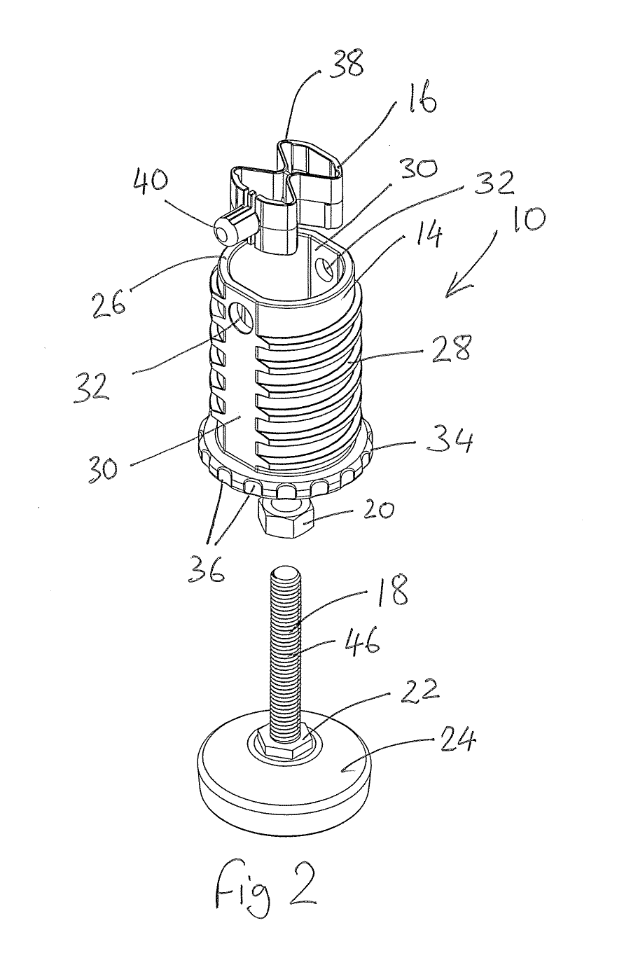

FIG. 2 is a diagrammatic exploded perspective view of the arrangement of FIG. 1;

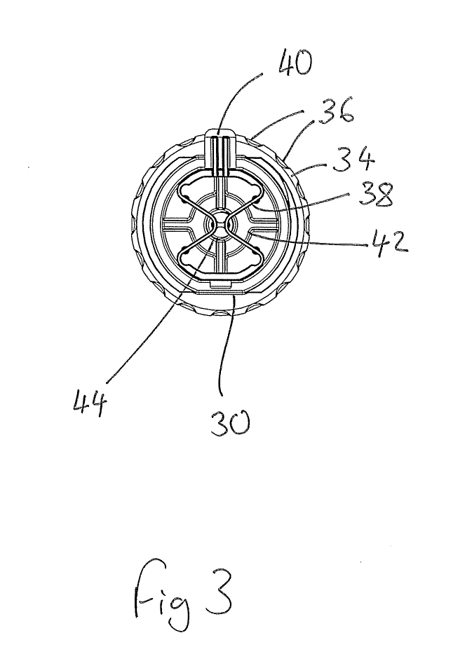

FIG. 3 is a diagrammatic plan view of the arrangement of FIG. 1; and

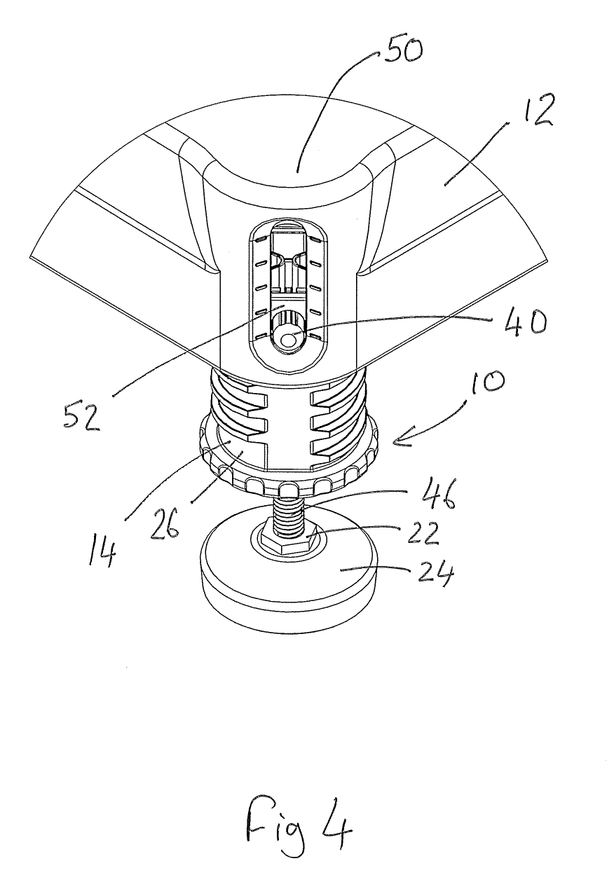

FIG. 4 is a diagrammatic perspective view of an adjustable height assembly including the arrangement of FIG. 1.

The drawings show a height adjustment arrangement 10 for an item such as a platform 12, part of which is illustrated in FIG. 4. The arrangement 10 includes a hollow first member 14, a stop member 16, an elongate second member 18, first and second nuts 20, 22, and a foot 24.

The first member 14 has a generally hollow cylindrical configuration with a hollow body 16 with an external thread 18 provided around the exterior of the body 16 except for two diametrically opposite flat portions 30. A circular hole 32 is provided towards the top end of each of the flat portions 30. A larger diameter flange 34 is provided at the lower end of the body 26, and has a plurality of recesses 36 therein to aid manual rotation of the body 26.

The stop member 16 comprises a resilient part 38 locatable within the body 26 and a stop part in the form of a finger 40 which extends from the resilient part 38 and is selectively extendible through a one of the holes 32. The stop member 16 is integrally formed of a plastics material. The finger 40 is solid, but the resilient part 38 comprises a profiled relatively thin strip of material extending from the finger 40 with two interconnected M shapes where each of the ends of the M′s interconnect, and the central valleys substantially contact each other. This means that in a rest position the finger 40 extends outwardly through a one of the holes 32, but can be pressed into the interior of the body 26 with the resilient part 38 flexing.

A cruciform structure 42 extends across the lower end of the body 26 and provides a central threaded part 44. The second member 18 is in the form of a threaded bar 46, which is engageable with the first member threaded part 44, such that the amount of the bar 46 extending into the body 26 of the first member 14 can be varied to provide height adjustment. The first nut 20 can be moved along the threaded bar 46 to abut against the lower end of the cruciform structure 42, to retain the bar 46 in a required position relative to the body 26.

The foot 24 is provided which has a threaded central hole to receive a lower end of the bar 46. The second nut 22 is mounted on the bar 46 and can be tightened against the foot 24 to retain the bar 46 in position on the foot 24.

FIG. 4 shows part of an item in the form of a platform 12 which would have at least one such arrangement 10 at each corner to provide height adjustment therefor. At each corner of the platform 12 a recess 50 is provided which can receive at least a part of the first member 14. The recess 50 is internally threaded to engage with the thread 28 on the body first member 26. A vertical slot 52 is provided on the outer apex of the recess 50 and is of a size to receive the finger 40 extending therethrough.

In use a first height adjustment can be made by rotating the first member 14 relative to the platform 12. If the finger 40 has engaged with the slot 52 as shown in FIG. 4, then the finger 40 can be pushed inwardly against the urging of the resilient part 38 to enable the finger 40 to move past the slot 52. The first member 14 can be rotated to a required position and respective height relative to the platform 12, and will be retained in this position by engagement of the finger 40 in the slot 52.

The first nut 20 can then be loosened if required and the bar 46 and foot 24 mounted thereto can be rotated relative to the first member 14 to provide further height adjustment. Once the bar 46 is in a required position, the first nut 20 can be tightened against the lower end of the first member body 26 to retain the bar 46 in the required position.

There is thus provided a height adjustment arrangement which provides for readily variable adjustment which can be securely held once in a required position. As height adjustment is provided respectively by engagement of the first member with the platform, and also engagement of the second member with the first member, a double height adjustment is provided which only requires a relatively limited amount of vertical space in the item such as the recesses in the platform, due to the adjustable second member being receivable within the body of the first member.

It is to be realised that a wide range of amendments may be made without departing from the scope of the invention. For instance the retaining nuts may not be required. A different locking arrangement can be used. A different spring urging configuration may be used.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A height adjustment arrangement for an item, the arrangement including a hollow first member with an external thread which is engageable with a thread on the item to permit relative height adjustment, and an elongate second member which has an external thread which is engageable with a thread in the interior of the first member to permit relative height adjustment.

2. An arrangement according to claim 1, in which a stop member is provided on the first member which is selectively engageable with the item to selectively prevent relative rotational movement between the first member and the item.

3. An arrangement according to claim 2, in which the stop member is automatically engageable with the item.

4. An arrangement according to claim 2, in which the arrangement is configured such that once engaged the stop member requires manual disengagement from the item before the first member can be rotated relative to the item.

5. An arrangement according to claim 2, in which the stop member is spring urged outwardly relative to the remainder of the first member.

6. An arrangement according to claim 5, in which the stop member includes a resilient part which is located within the first member, and a stop part which is selectively extendible outwardly from the first member.

7. An arrangement according to claim 6, in which the first member includes a hollow body within which the resilient part of the stop member is located.

8. An arrangement according to claim 7, in which an opening is provided in the hollow body through which the stop part is selectively extendible.

9. An arrangement according to claim 5, in which the stop part is engageable with an opening in the item.

10. An arrangement according to claim 9, in which the opening in the item is in the form of at least generally vertically extending slot.

11. An arrangement according to claim 2, in which the stop member is integrally formed.

12. An arrangement according to claim 2, in which the stop member is made of plastics material.

13. An arrangement according to claim 1, in which a foot is provided on the lower end of the elongate second member.

14. An arrangement according to claim 13, in which the second member is threadably engaged with the foot.

15. An arrangement according to claim 14, in which a nut is provided on the second member to retain the foot and second member mounted together.

16. An arrangement according to claim 1, in which a thread is provided at a lower end in use of the first member, with which the second member threadably engages.

17. An arrangement according to claim 1, in which a nut is provided on the second member selectively engageable with the first member to retain the first and second members mounted together at a required relative height.

18. An arrangement according to claim 1, in which the second member is in the form of a threaded bar.

19. An arrangement according to claim 1, in which the first member is integrally formed.

20. An arrangement according to claim 1, in which the first member is made of plastics material.

21. An adjustable height assembly, the assembly including an item and a height adjustment arrangement, the height adjustment arrangement including a hollow first member with an external thread which is engageable with a thread on the item to permit relative height adjustment, and an elongate second member which has an external thread which is engageable with a thread in the interior of the first member to permit relative height adjustment.

22.-24. (canceled)
